(19) United States
(12) Patent Application Publication
(10) Pub. No.: US 2022/0216763 A1
(43) Pub. Date: Jul. 7, 2022

(54) Rotating Machine

(71) Applicant: Fairway Electronic CO., LTD., New Taipei City (TW)

(72) Inventors: LIN-HAN YEN, New Taipei City (TW); YU-JEN FANG, New Taipei City (TW)

(21) Appl. No.: 17/141,606

(22) Filed: Jan. 5, 2021

(51) Int. Cl. H02K 5/10

(52) U.S. Cl. CPC H02K 5/10

(57) ABSTRACT

A rotating machine comprises a housing, a rotating shaft and an oil seal structure. The housing has an opening. The rotating shaft extends from the inside of the housing through the opening to the outside of the housing. The oil seal structure is set at the opening. The oil seal structure includes a body, an annular groove and an annular elastic structure. The body has a through hole to accommodate the rotating shaft. The annular groove is located on the surface of the body facing the outside of the housing and surrounds the through hole. The annular elastic structure is arranged in the annular groove to apply force to the rotating shaft. Thereby, the connection between the oil seal structure and the rotating shaft can be strengthened to ensure the sealing effect and prevent external moisture from entering the housing.

### BACKGROUND OF THE INVENTION

### Field of the Invention

The present invention relates to a rotating machine, and in particular to a rotating machine using an oil seal structure.

### Description of the Related Art

Rotating machines usually need lubricating oil for lubrication during operation, which can effectively reduce machine wear and increase service life. However, the rotating machine may also have oil leakage phenomenon, that is, the lubricating oil will leak to the outside. In order to avoid oil leakage, oil seals are generally used in the rotating machines.

The oil seal is a kind of sealing component that is sleeved outside the rotating shaft to prevent the lubricating oil from leaking to the outside and ensure the normal operation of the rotating shaft. However, when the rotating machine is used in a moisture-rich environment, such as swimming pools, car wash workshops, etc., the pressure difference between the interior and the outside of the housing of the rotating machine may drive external moisture to enter the interior of the rotating machine. In other words, the conventional oil seal cannot effectively prevent the external moisture from entering the housing of the rotating machine, which may affect the normal operation and service life of the rotating machine.

### BRIEF SUMMARY OF THE INVENTION

In order to overcome the above mentioned problems, it is an object of the present invention to provide a rotating machine, which is capable to strengthen the connection between the oil seal structure and the rotating shaft, improve the sealing performance of the oil seal structure, avoid external moisture intruding into the shell, ensure the normal operation of the rotating machine, and extend the service life of the rotating machine.

The present invention provides a rotating machine. The rotating machine comprises a housing, a rotating shaft and an oil seal structure. The housing has an opening. The rotating shaft extends from an interior of the housing through the opening to an exterior of the housing. The oil seal structure is set at the opening. The oil seal structure includes a body, an annular groove and an annular elastic structure. The body has a through hole to accommodate the rotating shaft. The annular groove is located on the surface of the body facing the outside of the housing and surrounds the through hole. The annular elastic structure is arranged in the annular groove to press against the rotating shaft.

In an embodiment, the body comprises a supporting structure and a covering structure, the covering structure covering the supporting structure, the annular groove divides the covering structure into an inner covering structure and an outer covering structure, and the inner covering structure is connected to the outer covering structure.

In an embodiment, a cross section of the supporting structure along a longitude direction is L-shaped.

In an embodiment, the supporting structure comprises a vertical segment and a horizontal segment, and a thickness of the vertical segment is greater than a thickness of the horizontal segment.

In an embodiment, the supporting structure is made of a metallic material, and the covering structure is made of a rubber material.

In an embodiment, the annular groove has a curved surface on a side away from the through hole.

In an embodiment, the curved surface extends from an open of the annular groove to a bottom of the annular groove.

In an embodiment, the annular groove has an inclined surface on a side away from the through hole, and the inclined surface is inclined toward the through hole.

In an embodiment, a depth of the annular groove is ranged between ⅓ and ⅔ of a height of the body.

In an embodiment, the annular elastic structure is a coil spring.

It is therefore an object of the present invention to provide a rotating machine, which is capable to strengthen the connection between the oil seal structure and the rotating shaft, improve the sealing performance of the oil seal structure, avoid external moisture intruding into the shell, ensure the normal operation of the rotating machine, and extend the service life of the rotating machine.

### BRIEF DESCRIPTION OF THE DRAWINGS

FIG. 1 is a schematic sectional view of the rotating machine of the present invention.

FIG. 2 is a schematic sectional view of the oil seal structure in accordance with an embodiment of the present invention.

FIG. 3 is a schematic sectional view of the oil seal structure in accordance with another embodiment of the present invention.

### DETAILED DESCRIPTION OF THE EMBODIMENTS

These and other features, aspects and advantages of the present invention will become better understood with regard to the following description, appended claims, and accompanying drawings.

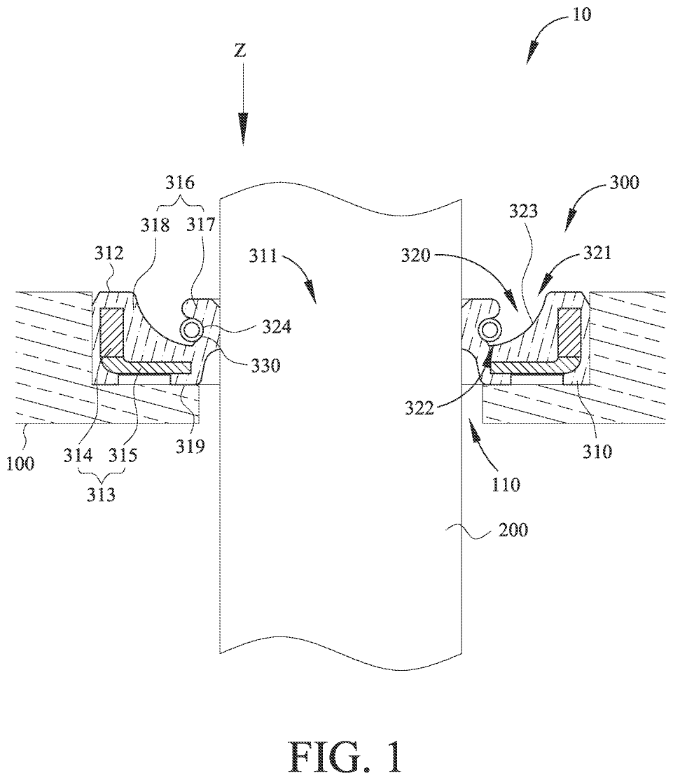

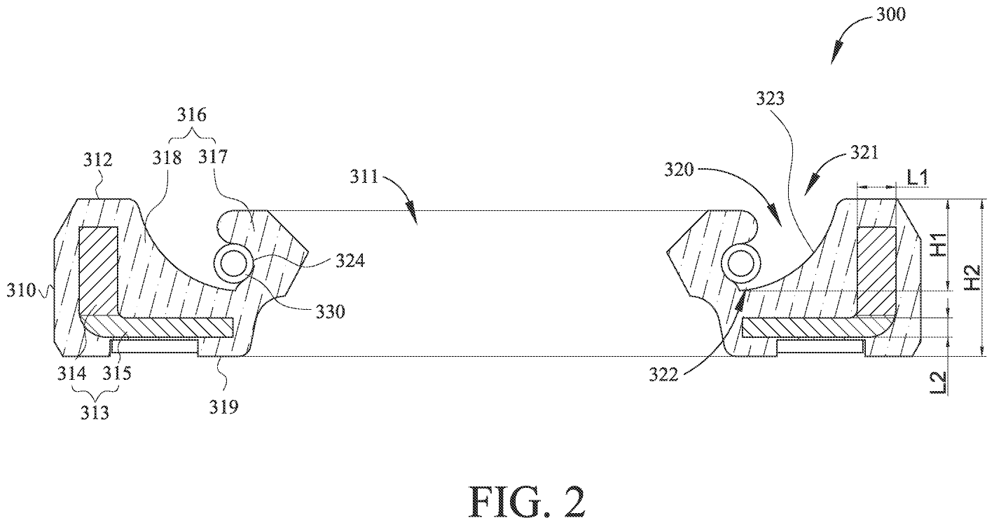

Please refer to FIG. 1 to FIG. 2, a rotating machine is provided in accordance with the first embodiment of the present invention. The rotating machine 10 comprises a housing 100, a rotating shaft 200 and an oil seal structure 300. Looking further, the housing 100 is provided with an opening 110. It should be noted that when the oil seal structure 300 is installed on the housing 100, the oil seal structure 300 will undergo a certain degree of deformation to closely fit the housing 100 and the rotating shaft 200.

The rotating shaft 200 extends from an interior of the housing 100 through the opening 110 of the housing 100 to an exterior of the housing 100. From the perspective of FIG. 1, the rotating shaft 200 penetrates the housing 100 through the opening 110 from bottom to top. The oil seal structure 300 is installed at the opening 110 of the housing 100, that is, it is sleeved on the rotating shaft 200 to avoid leakage of lubricating oil. Further, the oil seal structure 300 comprises a body 310, an annular groove 320, and an annular elastic structure 330. An installation direction Z of the oil seal structure 300 is from the outside of the housing 100 to the inside of the housing 100. According to the installation direction Z, the body 310 defines an outer surface 312 and an inner surface 319. In one embodiment, the annular elastic structure 330 is a coil spring.

The body 310 has a through hole 311 for receiving the rotating shaft 200. In other words, the rotating shaft 200 penetrates through the through hole 311 to be sleeved by the oil seal structure 300. The annular groove 320 is located on the surface of the main body 310 facing the outside of the housing 100. As understood from the figure, the annular groove 320 is located on the outer surface 312 of the main body 310. In addition, the annular groove 320 surrounds the through hole 311. The annular elastic structure 330 is disposed in the annular groove 320, and the contraction force of the annular elastic structure 330 can be applied to the rotating shaft 200, so that the oil seal structure 300 is sleeved on the rotating shaft 200 and has better sealing performance. In addition, when the body 310 has fatigue loss after a period of use, the tightening force of the annular elastic structure 330 will compensate for the fatigue loss of the body 310, so that the oil seal structure 300 continues to maintain the sealing effect.

To further explain, when the rotating machine 10 of this case is placed in a liquid or a place rich in moisture, for example, when operating in water, because the annular groove 320 is located on the outer surface 312 of the body 310, that is, it faces the shell. On the outside of the housing 100, the annular elastic structure 330 is exposed to water. In other words, the water flow enters the annular groove 320 and exerts pressure on the annular elastic structure 330, so that the oil seal structure 300 and the rotating shaft 200 are connected more closely, and the annular elastic structure 330 can be tightened to further strengthen the sealing effect. The good sealing effect can not only prevent the leakage of lubricating oil, but also prevent foreign objects such as external moisture and sand from entering the interior of the rotating machine 10, effectively protecting the normal operation of the rotating machine 10 and extending its service life.

In an embodiment, a motor is provided inside the rotating machine 10, and the motor is used to drive the rotating shaft 200 to rotate in response to usage requirements.

In an embodiment, as shown in FIGS. 1 and 2, the body 310 comprises a supporting structure 313 and a covering structure 316. The supporting structure 313 is a skeleton, so that the oil seal structure 300 can maintain the shape and tension. The covering structure 316 is covering the supporting structure 313. The annular groove 320 divides the covering structure 316 into an inner covering structure 317 and an outer covering structure 318, and the inner covering structure 317 is connected to the outer covering structure 318. The outer covering structure 318 is connected to the housing 100, and the inner covering structure 317 is sleeved on the rotating shaft 200. Looking further, the longitudinal section of the supporting structure 313 is L-shaped. In other words, the supporting structure 313 comprises an integrally formed vertical segment 314 and a horizontal segment 315, the vertical segment 314 is connected to the horizontal segment 315, and a thickness L1 of the vertical segment 314 is greater than a thickness L2 of the horizontal segment 315 to enhance the overall structure of the oil seal structure 300 strength. The thicker vertical segment 314 also helps to install the oil seal structure 300 in the opening 110 of the housing 100 and at the same time ensures the tightness of the oil seal structure 300 and the side wall of the opening 110.

In an embodiment, the supporting structure 313 is made of an metallic material as the skeleton of the body 310 to ensure a certain structural strength. The covering structure 316 is made of a elastic material, such as rubber, to facilitate installation. Utilizing the elastic restoring force generated by the deformation of the covering structure 316, the body 310 can be tightly installed between the side wall of the opening 110 and the rotating shaft 200. But this case is not limited to this. Moreover, in an embodiment, the main body 310 may also be integrally formed.

In an embodiment, as shown in FIG. 2, the annular elastic structure 330 substantially surrounds the middle of the inner covering structure 317. In order to effectively apply water pressure to the inner covering structure 317 and ensure the structural strength of the body 310, a depth H1 of the annular groove 320 is ranged between ⅓ and ⅔ of a height H2 of the body 310. It is worth noting that the depth H1 of the annular groove 320 is the distance from a groove open 321 of the annular groove 320 to a groove bottom 322 of the annular groove 320. The height H2 of the body 310 is the distance from the outer surface 312 of the body 310 to its inner surface 319.

In an embodiment, as shown in FIG. 2, the annular groove 320 has a U-shaped surface 324 on the side close to the through hole 311. The U-shaped surface 324 is used to accommodate the annular elastic structure 330. In an embodiment, the U-shaped surface 324 extends from the groove bottom 322 of the annular groove 320 to half the depth H1 of the annular groove 320 to position the annular elastic structure 300. Thereby, the pressure generated by the liquid can be effectively applied to the inner covering structure 317 and push the annular elastic structure 330.

In an embodiment, as shown in FIG. 2, the annular groove 320 has an curved surface 323 on the side away from the through hole 311. The curved surface 323 extends from the groove open 321 of the annular groove 320 toward the inner covering structure 317 to the groove bottom 322 of the annular groove 320. The annular elastic structure 330 is disposed in the annular groove 320 and is adjacent to the groove bottom 322. With the arrangement of the curved surface 323, when the rotary machine 10 of this case is placed in a liquid to work, the pressure generated by the liquid can be effectively applied to the inner covering structure 317 and push the annular elastic structure 330 to further strengthen the connection between the body 310 and the rotating shaft 200, which enhances the sealing effect and prevents external liquid from entering the housing 100.

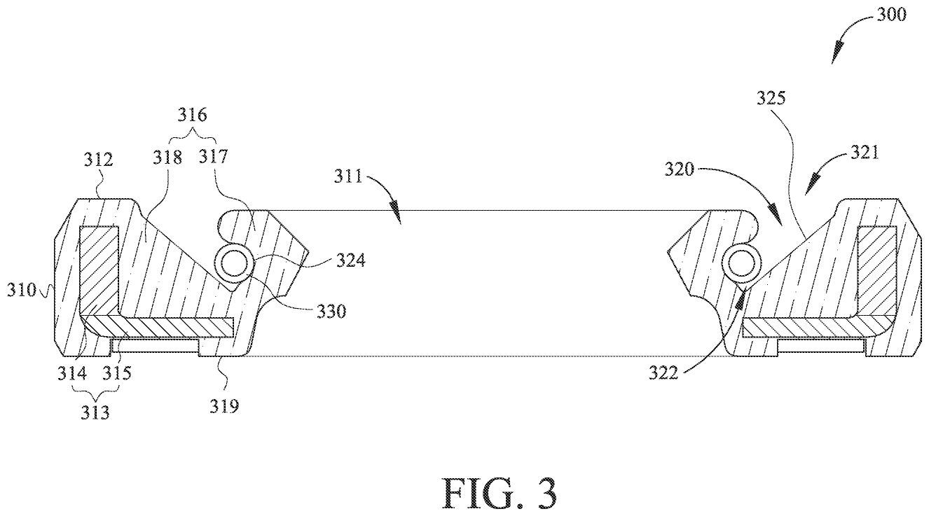

In another embodiment, as shown in FIG. 3, the annular groove 320 forms an inclined surface 325 inclined toward the through hole 311 on the side away from the through hole 311, and the inclined surface 325 is formed by the groove open 321 of the annular groove 320. It extends toward the inner covering structure 317 to the bottom 322 of the annular groove 320, so that the pressure generated by the liquid is effectively applied to the inner covering structure 317 and pushes the annular elastic structure 330 to improve the sealing effect. To further illustrate, in order to enhance the sealing effect of the oil seal structure 300, the inclined surface 325 is not limited to the straight inclined surface 325 in FIG. 3, and can also be other forms of inclined surfaces, such as irregular inclined surfaces, which only need to face through hole 311. The tilting effect can effectively apply the pressure generated by the liquid to the inner covering structure 317 and push the annular elastic structure 330 to improve the sealing effect.

In summary, by using the rotating machine 10 provided by the present invention, when the rotating machine 10 is operating in liquid, such as water, the annular groove 320, which is located on the outer surface 312 of the body 310 and faces the outside of the housing 100, may allow the water to flow into the annular groove 320 to exert a pressure force on the inner covering structure 317 and push the annular elastic structure 330 accommodated in the annular groove 320. Thereby, the annular elastic structure 330 may exert a force on the rotating shaft 200 to have the body 310 and the rotating shaft 200 firmly connected with each other. Thereby, the sealing performance of the oil seal structure 300 may be improved, and the external objects such as water and dusty air may be blocked from the outside of the housing 100 to guarantee the normal operation of the rotating machine 10 and extend its service life.

Although the present invention has been described in considerable detail with reference to certain preferred embodiments thereof, the disclosure is not for limiting the scope of the invention. Persons having ordinary skill in the art may make various modifications and changes without departing from the scope. Therefore, the scope of the appended claims should not be limited to the description of the preferred embodiments described above.

What is claimed is:

1. A rotating machine, comprising:
a housing with an opening;
a rotating shaft extending from an interior of the housing through the opening to an exterior of the housing; and
an oil seal structure installed at the opening, and the oil seal structure comprising:
a body with a through hole to accommodate the rotating shaft;
an annular groove located on a surface of the body facing the exterior of the housing and surrounding the through hole; and
an annular elastic structure arranged in the annular groove to press against the rotating shaft.

2. The rotating machine according to claim 1, wherein the body comprises a supporting structure and a covering structure, the covering structure covers the supporting structure, the annular groove divides the covering structure into an inner covering structure and an outer covering structure, and the inner covering structure is connected to the outer covering structure.

3. The rotating machine according to claim 2, wherein a cross section of the supporting structure along a longitude direction is L-shaped.

4. The rotating machine according to claim 3, wherein the supporting structure comprises a vertical segment and a horizontal segment, and a thickness of the vertical segment is greater than a thickness of the horizontal segment.

5. The rotating machine according to claim 2, wherein the supporting structure is made of a metallic material, and the covering structure is made of a rubber material.

6. The rotating machine according to claim 1, wherein the annular groove has a curved surface on a side away from the through hole.

7. The rotating machine according to claim 6, wherein the curved surface extends from an open of the annular groove to a bottom of the annular groove.

8. The rotating machine according to claim 1, wherein the annular groove has an inclined surface on a side away from the through hole, and the inclined surface is inclined toward the through hole.

9. The rotating machine according to claim 1, wherein a depth of the annular groove is ranged between ⅓ and ⅔ of a height of the body.

10. The rotating machine according to claim 1, wherein the annular elastic structure is a coil spring.
